(19) United States
(12) Patent Application Publication
(10) Pub. No.: US 2012/0192398 A1
(43) Pub. Date: Aug. 2, 2012

(54) Process Gas Conduits Having Increased Usage Lifetime and Related Methods

(75) Inventor: Francis Vo, Union City, CA (US)

(73) Assignee: Greene, Tweed of Delaware, Inc.

(21) Appl. No.: 13/197,846

(22) Filed: Aug. 4, 2011

Related U.S. Application Data
(60) Provisional application No. 61/371,451, filed on Aug. 6, 2010.

(51) Int. Cl. B23P 11/00; B29C 65/00; B32B 18/00

(52) U.S. Cl. 29/428; 156/345.29; 156/345.33; 156/294

(57) ABSTRACT

The invention described here relates to a gas injector for use in a semiconductor etching process or other processes involving aggressive gases or gas plasmas, and more particularly to a gas injector and gas conduits having extended usage life, and exhibiting less etching and particle generation with usage.

In most semiconductor manufacturing processes for the etching of a semiconductor wafer, the uppermost portion of a wafer is selectively removed through holes formed in a photoresist layer in the processes' etching step. The etching process is carried out in a sealed chamber into which gases or gas plasmas such as, for example, CF₄, CHF₃, O₂, NF₃, He, and argon gas are injected. Commonly, a gas supplying device and a gas injector are required to provide the gas(es) to the reaction chambers and to exhaust the gas(es) from the chamber once the process is completed. In addition to being exposed to the gases, these components may be exposed to the plasma etch process. Conventional gas supplying components are made of quartz. However, after repeated use (repeated injection/passage of process gases to chamber) the component parts through which the gas is passed (such as the gas injector tube) may become etched, thereby reducing their structural integrity, and, more significantly, generating particulates that can affect the integrity of the wafer etching process. Either outcome may result in costly defects in the wafers and/or inefficiency of the process. To avoid these and other problems, conventional quartz gas injector tubes are typically replaced frequently (or, typically have a PM lifetime of about 500 Radio Frequency (“RF”) Hrs).

### CROSS REFERENCE TO RELATED APPLICATION

This application claims the benefit under 35 U.S.C. §119(e) of U.S. Provisional Patent Application No. 61/371,451, filed Aug. 6, 2010, entitled “Process Gas Conduits Having Increased Usage Lifetime and Related Methods”, the entire disclosure of which is incorporated herein by reference.

### BACKGROUND OF THE INVENTION

The invention described here relates to a gas injector for use in a semiconductor etching process or other processes involving aggressive gases or gas plasmas, and more particularly to a gas injector and gas conduits having extended usage life, and exhibiting less etching and particle generation with usage.

In most semiconductor manufacturing processes for the etching of a semiconductor wafer, the uppermost portion of a wafer is selectively removed through holes formed in a photoresist layer in the processes' etching step. The etching process is carried out in a sealed chamber into which gases or gas plasmas such as, for example, CF₄, CHF₃, O₂, NF₃, He, and argon gas are injected. Commonly, a gas supplying device and a gas injector are required to provide the gas(es) to the reaction chambers and to exhaust the gas(es) from the chamber once the process is completed. In addition to being exposed to the gases, these components may be exposed to the plasma etch process. Conventional gas supplying components are made of quartz. However, after repeated use (repeated injection/passage of process gases to chamber) the component parts through which the gas is passed (such as the gas injector tube) may become etched, thereby reducing their structural integrity, and, more significantly, generating particulates that can affect the integrity of the wafer etching process. Either outcome may result in costly defects in the wafers and/or inefficiency of the process. To avoid these and other problems, conventional quartz gas injector tubes are typically replaced frequently (or, typically have a PM lifetime of about 500 Radio Frequency (“RF”) Hrs).

### BRIEF SUMMARY OF THE INVENTION

The invention encompasses a conduit for the ingress and/or egress of a process gas to a reaction chamber that includes (a) an inner core having an interior surface and an exterior surface and (b) an outer sleeve having an interior surface and exterior surface, wherein the inner core exterior surface is joined to the outer sleeve interior surface. In addition, the conduit may serve as a light or data conduit, that is, for example, it may be an assembly including a visual port or sensor that conveys data, light or other detectable information from a reaction chamber to a portal. See, for example, FIGS. 2, 3, 4 and 5.

The inner core is fabricated of a material chosen from sapphire. The outer sleeve includes a material selected from aluminum oxide (Al₂O₃), quartz, sapphire, aluminum nitride, yttria, alumina, zirconia, yttria stabilized zirconia, AlON, Si AlON and combinations thereof.

Also included are hybrid gas injectors for use in a semiconductor etching processes. The injectors include at least one gas line, wherein the at least one gas line comprises an inner core having an interior surface and an exterior surface and an outer sleeve having an interior surface and exterior surface. The inner core exterior surface is joined to the outer sleeve interior surface. The inner core is fabricated of sapphire and the outer sleeve comprises a material selected from aluminum oxide (Al₂O₃), quartz, sapphire, aluminum nitride, yttria, alumina, zirconia, yttria stabilized zirconia, AlON, Si AlON, and combinations thereof.

Also included are methods of increasing the PM lifetime of a conduit used for the ingress and/or egress of a process gas to a reaction chamber. Such methods include fabricating the conduit out of: (a) an inner core having an interior surface and an exterior surface and (b) an outer sleeve having an interior surface and exterior surface, wherein the inner core exterior surface is joined to the outer sleeve interior surface. The inner core is fabricated of sapphire and the outer sleeve comprises a material selected from aluminum oxide (Al₂O₃), quartz, sapphire, aluminum nitride, yttria, alumina, zirconia, yttria stabilized zirconia, AlON, Si AlON and combinations thereof. The PM lifetime of the conduit is greater than the PM lifetime of a conventional quartz conduit subjected to identical process conditions.

Included are methods of manufacturing a conduit for the ingress and/or egress of a process gas to a reaction chamber comprising joining an inner core having an interior surface and an exterior surface and (b) an outer sleeve having an interior surface and exterior surface, wherein the inner core exterior surface is joined to the outer sleeve interior surface; and the inner core is fabricated of sapphire and the outer sleeve comprises a material selected from aluminum oxide (Al₂O₃), quartz, sapphire, aluminum nitride, yttria, alumina, zirconia, yttria stabilized zirconia, AlON, Si AlON and combinations thereof.

### BRIEF DESCRIPTION OF THE DRAWINGS

The foregoing summary, as well as the following detailed description of the invention, may be better understood when read in conjunction with the appended drawings. However, the invention is not limited to the precise arrangements and instrumentalities shown. In the drawings:

FIG. 1 is an schematic drawing of a long section of the conduit;

FIG. 2 is an exemplary coaxial tube assembly with visual port, shown in perspective view;

FIG. 3 is the exemplary coaxial tube assembly with visual port of FIG. 2, shown in longitudinal section;

FIG. 4 is an exemplary gas injector structure, shown in perspective view; and

FIG. 5 is the exemplary gas injector structure of FIG. 4, shown in longitudinal section view.

### DESCRIPTION OF THE INVENTION

The invention relates to conduits for the ingress and/or egress of a process gas, process gas plasma or other gaseous substance such as carrier gas (hereinafter collectively referred to as “process gas”) to a reaction chamber, as part of a processing system; processing systems (such as gas injectors) that contain the conduits; and various related methods. Such processing systems may be sued in the preparing (etching) of semiconductor wafers, although the conduits and methods described herein may pertain to any processing system in which process gases are used, for example, chemical vapor disposition (“CVD”) (including plasma-enhanced CVD), etching (including shallow trench isolation (“STI”) etching and hard mask etching), and high temperature film deposition.

Process gases may include any used in the above-described process (or used to clean the equipment) and combinations of the same. Examples may include CF₄, CHF₃, O₂, NF₃, He, argon gas and any carrier gases. In the case of semiconductor processing, wafers are typically processed by positioning the wafer in a chamber and subjecting the surface of the wafer to various process gases and/or chemicals carried by carrier gases. The chemistry of the gas or mixture selected depends upon the type of processing employed as well as the nature of the devices formed on the surface of the semiconductor wafer. The process gases are supplied to the reaction chamber via a gas injector system, many models and configurations of which have been devised over the years.

Typically, the gas injector system includes a plenum that is in communication with a gas source and a one or more nozzles for injecting the gases from the plenum into the reaction chamber. To transfer the process gas from the gas source, to the plenum and ultimately to facilitate ingress to the reaction chamber via the nozzle, various conduits or enclosed pathways (occasionally commonly referred to as “gas lines”) are provided through which the process gases flow. Similarly, when the process gases are exhausted from the reaction chamber, various configurations of conduits are provided for the egress of the process gas from the reaction chamber and into a suitable location for disposal or recycling. Exemplary gas injector systems and/or components that include conduits which may be replaced by the conduits of the invention include any known or to be developed in the art and include, for example, those shown in U.S. Pat. Nos. 5,851,294; 5,453,124; 5,783,023; 5,422,139; 6,296,710; and 4,232,063, the contents of each of which are incorporated herein by reference.

The invention includes a conduit for the ingress and/or the egress of a process gas to a reaction chamber. The ingress or egress of the process gas may be direct (that is, the conduit is situated within the system to deliver the process gas directly to the reaction chamber) or indirect (that is, the conduit is situated in the system upstream or downstream of the reaction chamber, but the process gas passes through the conduit(s) on its path to or from the reaction chamber) or any combination of the two.

The conduit may be of any configuration, preferable substantially annular in cross section (so that viewed in perspective it is a tube-like structure) or it may have a configuration in cross section of a non-solid polygon, for example, a square, hexagon, rectangle configuration in cross section.

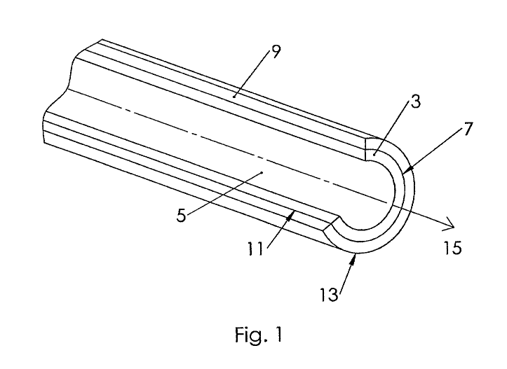

FIG. 1 shows a schematic diagram of an exemplary conduit in long section. The conduit includes and inner core 3 that is joined to the outer sleeve 9. The inner core 3 has an interior surface 5 (facing the gas transit pathway 15) and an exterior surface 7. Similarly, the outer sleeve 9 has an interior surface 11 and an exterior surface 13.

The inner core 3 is designed to be situated within the outer sleeve 9 and shield substantially most of the outer sleeve interior surface 11 from the gas transit pathway 15. Accordingly, it may be preferred that the inner core 3 is substantially contiguous with the outer core interior surface 11; however, it is recognized that in some circumstances it may not be necessary. Because the inner core 3 is placed within the outer sleeve 9, the cross sectional circumference (or perimeter, if the conduit is a polygon) of the inner core 3 will be smaller than that of the outer sleeve 9. The size difference will vary depending on several factors, including the mechanism by which the inner core 3 is joined to the outer sleeve 9.

In some embodiments, one may detachably or reversibly join the outer sleeve to the inner core. This may allow for greater flexibility in cleaning, repair and or replacement of either the inner core or the outer core independently.

In the conduit, the inner core 3 is fabricated of aluminum oxide (Al₂O₃), quartz, sapphire, aluminum nitride, yttria, alumina, zirconia, yttria stabilized zirconia, AlON, Si AlON, and/or combinations thereof. In some embodiments, sapphire may be preferred. Any sapphire material suitable for use in semiconductor applications and/or having chemical, heat and/or plasma resistance may be used.

The outer sleeve may be made of a material chosen from aluminum oxide (Al₂O₃), quartz, sapphire, aluminum nitride, yttria, alumina, zirconia, yttria stabilized zirconia, nitride based ceramics (such as AlON or Si AlON) and combinations thereof.

It may be preferred, however, that the outer sleeve and the inner core are made of different materials.

Preferably, each of the inner core and the outer sleeve are formed a unitary body. However in some instances it may be desirable to form, for example the inner core in two or more sections and assemble the sections together. Alternatively, for example, one may form the inner core as a unitary body, and assembly several pieces around the inner core, thereby forming the outer sleeve.

The inner core and the outer sleeve may be joined at their exterior and interior surfaces respectively. Joining may be accomplished by any means known in the art. Mechanical means, chemical means, and combinations of the same may be suitable. Exemplary joining means include brazing (which also includes the metalizing of the surfaces to be joined), deformation bonding, diffusion bonding, and/or transient liquid phase bonding.

In some circumstances (e.g., brazing), it may be desirable to join the inner core and the outer sleeve using a bonding aid. Examples may include a ceramic paste, a polymer, metal, and/or an organic bonding aid.

Mechanical means of joining may also be used, alone or in combination with those described above. For example, the surfaces may be joined by press fitting the inner core into the outer sleeve or by lamination (if the outer sleeve and inner core are not unitary pieces). Alternatively, one may use mechanical fasteners or interlocking mechanisms to join the outer sleeve and the inner core. Exemplary fasteners may include staples, nut-and-bolt assemblies, strapping, ties, clips, direct thread or interlocking keys, pins, screws, and retaining rings.

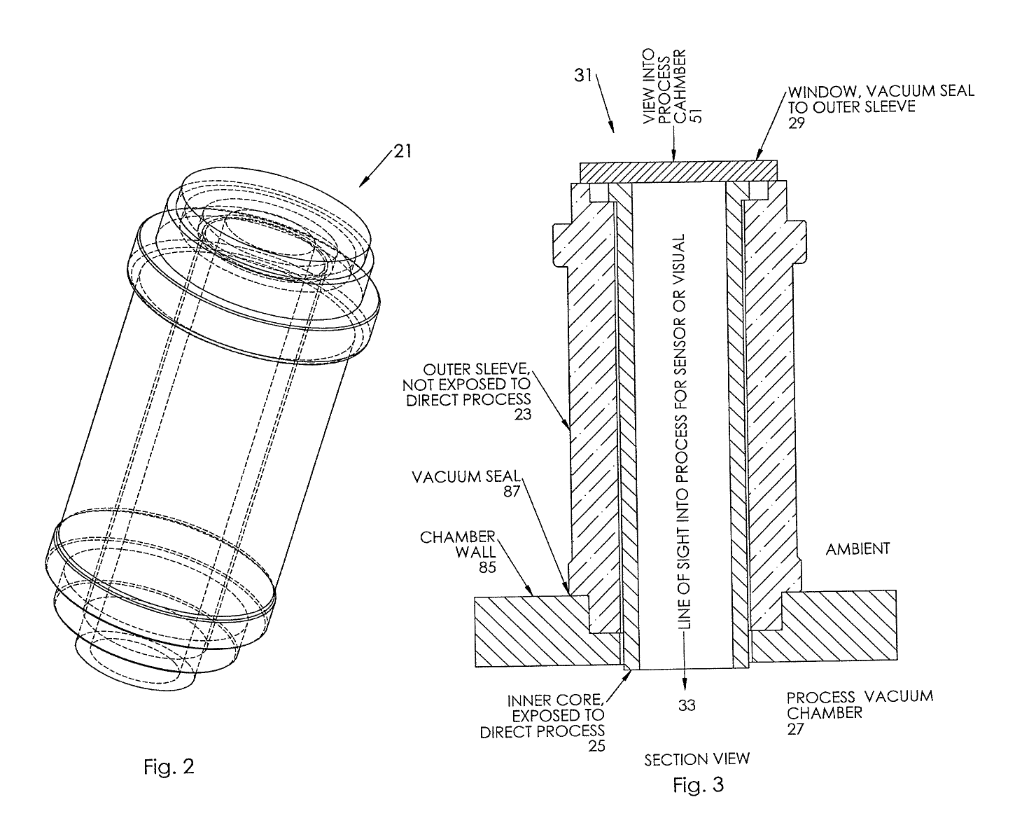

FIGS. 2 and 3 show an exemplary coaxial tube assembly 21 with visual port, shown in perspective view and in long section view, respectively. The visual port assembly 21 includes an inner core 25 and an outer sleeve 23, each of which is fabricated of the material(s) and in the manner described above. The inner core 25 extends slightly beyond the length of the outer sleeve 23 and projects into the process vacuum chamber 27. The inner core 25 is exposed to much harsher conditions than the outer sleeve 23. An end of the assembly 21 terminates in a sensor or visual port 31, which permits monitoring of the interior of the process vacuum chamber 27, via a hypothetical line of sight 33. The sensor or visual port 31 may include a vacuum tight window, e.g., 29, that is coupled or otherwise securely fastened to the outer sleeve 23. In some embodiments, the window may be detachably fastened, so it may be removed and/or replaced.

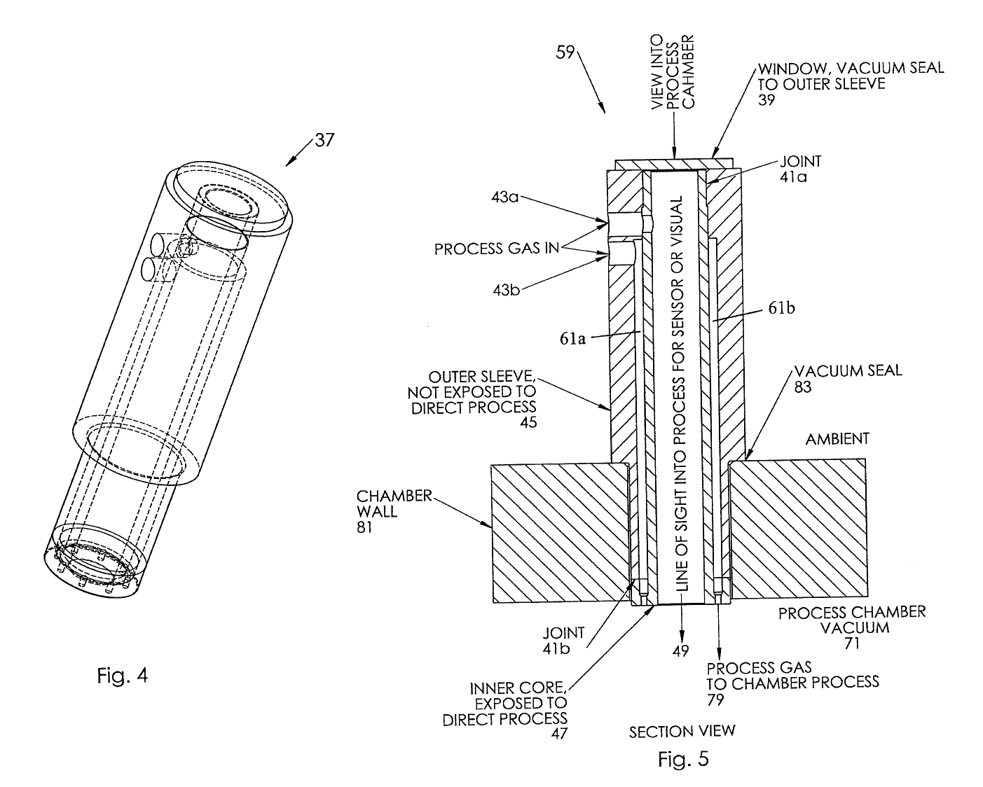

FIGS. 4 and 5 are exemplary gas injector assembly 37 with visual port 59, shown in perspective view and in long section. The inner core 47 and the outer sleeve 45 are made of the material and in the manner discussed above. Process gas is conveyed through ports 43a and 43b, thorough gas lines 61a and 61b and into reaction chamber 71. The inner core 47 extends beyond the length of the outer sleeve 45 and projects into the process vacuum chamber 71. The inner core 47 is exposed to much harsher conditions than the outer sleeve 45.

The assembly 37 extends into the reaction chamber 71, both to facilitate the delivery of process gas and to permit visual or sensor access to the reaction chamber. An end of the assembly terminates in a sensor or visual port 59, which permits monitoring of the interior of the process vacuum chamber 71, via a hypothetical line of sight 49. The sensor or visual port 59 may include a vacuum tight window, e.g., 39, that is coupled or otherwise securely fastened to the outer sleeve 45.

Conduits prepared in accordance with the invention have a greater usage lifetime than conduits prepared of conventional materials, such as quartz. For example, the conduits of the invention may have a PM lifetime that is greater than about 500 RF hrs. Alternatively, the conduits of the invention may have a PM lifetime that is greater than or equal to about 600, about 700, about 750, about 800, about 900, about 1000, about 1100, about 1200, about 1300, about 1400, about 1500, about 1600, about 1700, about 1800, about 1900, about 2000, about 2100, about 2200, about 2300, about 2400, about 2500, about 2600, about 2700, about 2800, about 2900, or about 3000.

The invention also includes conduits that are specifically used as gas lines in gas injector assemblies. Exemplary gas injector systems and/or components that include conduits which may be replaced by the conduits of the invention include any known or to be developed in the art and include, for example, those shown in U.S. Pat. Nos. 5,851,294; 5,453,124; 5,783,023; 5,422,139; 6,296,710; and 4,232,063, the contents of each of which are incorporated herein by reference.

Also contemplated within the scope of the invention are methods of preparing the conduits. Such methods include joining the inner core to the outer sleeve using the joining methods described above.

The invention includes methods of increasing the usage lifetime of a conduit used for the ingress and/or egress of a process gas to a reaction chamber by manufacturing the conduits as described above.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A conduit for the ingress and/or egress of a process gas to a reaction chamber comprising:
(a) an inner core having an interior surface and an exterior surface and
(b) an outer sleeve having an interior surface and exterior surface, wherein the inner core exterior surface is joined to the outer sleeve interior surface; and
the inner core is fabricated of a material chosen from aluminum oxide (Al₂O₃), quartz, sapphire, aluminum nitride, yttria, alumina, zirconia, yttria stabilized zirconia, AlON, Si AlON and combinations thereof and the outer sleeve comprises a material selected from aluminum oxide (Al₂O₃), quartz, sapphire, aluminum nitride, yttria, alumina, zirconia, yttria stabilized zirconia, AlON, Si AlON and combinations thereof, but where the inner core and the outer core include different materials.

2. The conduit of claim 1, wherein the inner core is fabricated of sapphire.

3. The conduit of claim 1, wherein the inner core exterior surface and the outer sleeve interior surface are metalized and the surfaces are joined by brazing.

4. The conduit of claim 1, the inner core exterior surface is bonded to the outer layer exterior surface a process selected from deformation bonding, transient liquid phase joining, and diffusion bonding.

5. The conduit of claim 1, wherein the inner core is bonded to the outer core by a bonding aid.

6. The conduit of claim 5, wherein the bonding aid is selected from metal, ceramic paste, an organic bonding aid, and a polymer.

7. The conduit of claim 1, the inner core exterior surface is bonded to the outer layer exterior surface by a mechanical joining process.

8. The conduit of claim 1, wherein the inner core and the outer sleeve are joined by press fitting.

9. The conduit of claim 1, the inner core and the outer sleeve are joined by a mechanical fastener.

10. The conduit of claim 9, wherein the mechanical fastener is chosen from staples, nut-and-bolt assemblies, strapping, ties, clips, direct thread or interlocking keys, pins, screws, and retaining rings.

11. A hybrid gas injector for use in a semiconductor etching process comprising at least one gas line, wherein the at least one gas line comprises an inner core having an interior surface and an exterior surface and an outer sleeve having an interior surface and exterior surface, wherein the inner core exterior surface is joined to the outer sleeve interior surface; and the inner core is fabricated of a material chosen from aluminum oxide (Al₂O₃), quartz, sapphire, aluminum nitride, yttria, alumina, zirconia, yttria stabilized zirconia, AlON, Si AlON, and combinations thereof, and the outer sleeve comprises a material selected from aluminum oxide (Al₂O₃), quartz, sapphire, aluminum nitride, yttria, alumina, zirconia, yttria stabilized zirconia, AlON, Si AlON, and combinations thereof.

12. The hybrid gas injector of claim 11, wherein the inner core is fabricated of sapphire.

13. The hybrid gas injector of claim 11, wherein the inner core exterior surface and the outer sleeve interior surface are metalized and the surfaces are joined by brazing.

14. The hybrid gas injector of claim 11, wherein the inner core exterior surface is joined to the outer layer exterior surface a process selected from deformation bonding, transient liquid phase joining, and diffusion bonding.

15. The hybrid gas injector of claim 11, wherein the inner core is joined to the outer core by a bonding aid.

16. The hybrid gas injector of claim 11, wherein the bonding aid is selected from metal, ceramic paste, an organic bonding aid, and a polymer.

17. The hybrid gas injector of claim 11, the inner core exterior surface is bonded to the outer layer exterior surface by a mechanical joining process.

18. The hybrid gas injector of claim 11, wherein the inner core and the outer sleeve are joined by press fitting.

19. The hybrid gas injector of claim 11, the inner core and the outer sleeve are joined by a mechanical fastener.

20. The hybrid gas injector of claim 11, wherein the mechanical fastener is chosen from staples, nut-and-bolt assemblies, strapping, ties, clips, direct thread or interlocking keys, pins, screws, and retaining rings.

21. A method of increasing the PM lifetime of a conduit used for the ingress and/or egress of a process gas to a reaction chamber comprising fabricating the conduit out of:
(a) an inner core having an interior surface and an exterior surface and
(b) an outer sleeve having an interior surface and exterior surface, wherein the inner core exterior surface is joined to the outer sleeve interior surface; and
the inner core is fabricated of a material chosen from aluminum oxide (Al₂O₃), quartz, sapphire, aluminum nitride, yttria, alumina, zirconia, yttria stabilized zirconia, AlON, Si AlON, and combinations thereof; and the outer sleeve comprises a material selected from aluminum oxide (Al₂O₃), quartz, sapphire, aluminum nitride, yttria, alumina, zirconia, yttria stabilized zirconia, AlON, Si AlON and combinations thereof,
wherein the PM lifetime of the conduit is greater than the PM lifetime of a conventional quartz conduit subjected to identical conditions.

22. The method of claim 21, wherein the PM lifetime of the conduit is greater than about 500 RF hrs.

23. The method of claim 21, wherein the PM lifetime of the conduit is greater than or equal to about 750 RF hrs.

24. The method of claim 21, wherein the PM lifetime of the conduit is greater than or equal to about 1000 RF hrs.

25. The method of claim 21, wherein the PM lifetime of the conduit is greater than or equal to about 2000 RF hrs.

26. The method of claim 21, wherein the PM lifetime of the conduit is greater than or equal to about 3000 RF hrs.

27. The method of claim 21, wherein the inner core is fabricated of sapphire.

28. The method of claim 21, wherein the inner core exterior surface and the outer sleeve interior surface are metalized and the surfaces are joined by brazing.

29. The method of claim 21, wherein the inner core exterior surface is bonded to the outer layer exterior surface a process selected from deformation bonding, transient liquid phase joining, and diffusion bonding.

30. The method of claim 21, wherein the inner core is bonded to the outer core by a bonding aid.

31. The method of claim 21, wherein the bonding aid is selected from metal, ceramic paste, an organic bonding aid, and a polymer.

32. The method of claim 21, the inner core exterior surface is bonded to the outer layer exterior surface by a mechanical joining process.

33. The method of claim 21, wherein the inner core and the outer sleeve are joined by press fitting.

34. The method of claim 21, wherein the inner core and the outer sleeve are joined by a mechanical fastener.

35. The method of claim 21, wherein the mechanical fastener is chosen from staples, nut-and-bolt assemblies, strapping, ties, clips, direct thread or interlocking keys, pins, screws, and retaining rings.

36. A method of manufacturing a conduit for the ingress and/or egress of a process gas to a reaction chamber comprising joining an inner core having an interior surface and an exterior surface and (b) an outer sleeve having an interior surface and exterior surface, wherein the inner core exterior surface is joined to the outer sleeve interior surface; and
the inner core is fabricated of sapphire and the outer sleeve comprises a material selected from aluminum oxide (Al₂O₃), quartz, sapphire, aluminum nitride, yttria, alumina, zirconia, yttria stabilized zirconia, AlON, Si AlON and combinations thereof.
